(19) United States
(12) Patent Application Publication
(10) Pub. No.: US 2008/0097952 A1
(43) Pub. Date: Apr. 24, 2008

(54) EXTENDING EMR - MAKING PATIENT DATA EMRCENTRIC

(75) Inventor: Kapali Eswaran, Alpharetta, GA (US)

Correspondence Address: Kapali Eswaran;C/O Integrated Informatics Inc., 1875 Old Alabama Road, Suite 725, Roswell, GA, 30076, US

(73) Assignee: Integrated Informatics Inc., Roswell, GA (US)

(21) Appl. No.: 11/538,925

(22) Filed: Oct. 5, 2006

(51) Int. Cl. G06F 17/30

(52) U.S. Cl. 707/1; 707/3

(57) ABSTRACT

Consider a user accessing a computer system providing inputs and getting information returned. The user may be interested in getting data stored in other systems being fetched based on the input that he had already given without having to explicitly access other systems and providing input. The user desires to avoid entering the same data input multiple times. A method is proposed to get (or put) information from (to) other systems without the user providing input data more than once. The method non-invasively captures the user's input and when commanded, fetches information from other systems using the captured data without the user having to access the other systems and provide input data again. The invention focuses on Electronic Medical Record (EMR) Systems that are deployed at physician offices. The invention extends an EMR system to access data stored outside the EMR system without modifying the EMR system, without requiring the EMR system to adhere to certain protocols or without requiring the user to enter the same input data multiple times.

### BACKGROUND OF THE INVENTION

An EMR system is a computer system that resides in a physician's office and provides for the electronic storage of patient records. An EMR system is specifically designed to support users by providing accessibility to complete and accurate data, alerts, reminders, clinical decision support systems, links to medical knowledge, and other aids. Examples of data available through an EMR system include history & physical information of patients, as well as medications prescribed to them. More often, the functions of an EMR system are bundled with the physician's office billing and scheduling system. These systems are designed to store and manage data for patients who are not bedridden; i.e., ambulatory care. Examples of commercially marketed EMR Systems are General Electric's Centricity and Misys EMR from Misys Corporation.

This invention extends an EMR system to access data stored outside the EMR system without modifying the EMR system, without requiring the EMR system to adhere to certain protocols or without requiring the user to enter the same input data multiple times.

Consider at scenario where a physician M prepares an order requisition for lab tests for a patient P. Assume that the lab tests are to be performed at a hospital H. It can be assumed, as may be the typical case, that the physician M collects samples for the tests in his office, as well as documents such as an Advanced Beneficiary Notice for patient P. A courier from the hospital H picks up the requisitions, Advanced Beneficiary Notices and samples few times a day.

In a second scenario, a physician M prepares an order requisition for lab tests for a patient, P. The lab tests are to be performed at a hospital H. In this scenario, it is assumed that the physician M gives the order requisition to patient P who goes to the hospital H to have the samples drawn, possibly sign documents such as Advanced Beneficiary Notice and then have the tests performed.

In both of the scenarios, the physician M needs to look at the results from the performing laboratory of hospital H. Assume that the physician office has an electronic medical record system (EMR). When a physician is accessing a particular patient's record, the physician would also like to see the laboratory results for that patient so that he can get a complete picture of the patient's health. Because doctors are typically overloaded and time is of the essence while at work, he or she would like to gain access to such laboratory results without having to log on to a different (second) application (which could be a browser), and enter one more time the patient information as an input to the second application. This desire of the physician-user could be achieved if the EMR System accepts results from hospital systems or laboratory, places the results in its own database and provides a user interface for gaining access to the stored laboratory data. However, such a capability is not possible unless the EMR System is modified and unless the said EMR system is compatible with certain industry standards such as CCOW and HL7. HL7 is a standard in healthcare industry that defines the protocols of the messages. CCOW is a standard in healthcare industry that defines sharing of objects (usually patient identifier) between multiple applications. Most of EMR systems available in the marketplace are neither HL7 nor CCOW compatible. Additionally, physicians may not like to store data such as laboratory results on their EMR, storing of which could affect storage requirements and performance of EMR.

Throughout this description, the term external data is used to mean information that come from sources other than the physician's office. Laboratory data from hospitals is an example of external data. Emails from consulting physicians, emails from patients, correspondence from insurance companies, radiology reports, radiology or pathology images or hyperlinks to such images are other examples of external data. A hyperlink is a pointer to an object stored somewhere in the network that when clicked fetches and displays the object.

What is needed in the art is a system and method that integrates external information sent from outside the physicians office or outside of the EMR system, into the EMR system for viewing and examination without requiring any modifications to the EMR system or without requiring the EMR system to be compatible with certain standards such as CCOW and HL7. There is also a need in the art that provides an examining physician or physician's assistant with access to data generated and made available from external sources without requiring the same to manage multiple accounts.

### BRIEF SUMMARY OF THE INVENTION

The present invention addresses the above-identified needs in the art, as well as other needs in the art described in the detailed description or that are apparent to those skilled in the art by providing a non-invasive methodology that is operable to serve as an intermediary between various systems. In general, one embodiment of the present invention integrates external data into an EMR system. For instance, when a physician navigates through his EMR system, he typically provides the necessary patient information to select or choose a patient, and gain access to review the physician office ambulatory data. The present invention further enables the function of fetching external information, if so desired by the physician, without the physician having to access and then once again provide patient information to the external source. Thus, in an embodiment of the present invention, the physician does not have to log on to the external source and provide patient identifier information yet one more time. In addition, the various aspects of the present invention work whether or not the EMR system is compatible with HL7 or CCOW, or any other standards and without the need for any modifications to the EMR System. As far as the physician is concerned, he or she simply operates in an EMR centric world.

Although the present invention may take on many varied forms, one embodiment of the invention may be described in terms of a set of computer programs ECS. ECS has three parts: Server, Client and Trainer. The ECS Server (ECS-S) operates to receive result messages from hospitals in industry standard formats, such as Health Level 7 (HL7), parse the received messages, associate the results of the parsing with an appropriate patient identifier (which is a part of the message) and then store the results in a database. The ECS Server is also equipped to receive other documents that are in non-industry standard formats. Non-limiting examples of such documents are radiology reports with or without images, insurance company communications or notes from consulting physicians sent by email, fax or other means of messaging. External documents could also include hyperlinks to information such as, images stored in a PAC (Picture Archiving and Communication) system. Generally, the patient identifier information is embedded in some place in these (non-standard) documents. Using templates, the ECS Trainer program (described later) can be used to train the ECS Server to first establish the document type and then find the identifier information in the document. Once a system has been trained with regards to particular document or message types, the ECS Server establishes the document type (such as radiology report from hospital x or an HL7 message from hospital y) and then finds the patient identifier in the document. Server then stores the document associating it to the patient identifier. In some cases, the ECS Server may simply fail to establish the document type and/or find the patient identification information in the document. When such scenarios arise, an embodiment of the present invention may revert to, or may enter and solicit human intervention.

The ECS Client software (ECS-C) is loaded into or onto the same physician's computer, or a computer accessible to the physician or physician's assistant, that runs the EMR system software. It should be noted that the ECS-C is a separate executable program that runs on the physician's PC and in no away modifies or affects the EMR System or the operation of the EMR System software. When the physician's PC is started, the ECS-C program also starts automatically. When the ESC-C program is initialized and running, it causes an icon, such as LR (stands for Lab Results) to be displayed in the PC's taskbar. When the physician has navigated himself to a specific patient on his EMR System, he simply clicks, selects or activates the LR icon on the taskbar to gain access to and look at the lab results of the said patient. The ECS-C operates to non-invasively capture the EMR patient context (i.e. the patient identification data which, as a non-limiting example, may include the patient's name, sex and date of birth) from the EMR application, provide the patient identification data to ECS-S, and get and display the lab data.

In an exemplary embodiment of the ECS-C, the ECS-C obtains the patient context from the EMR application using a non-invasive techniques, such as scraping the screen of the EMR application, screen buffer snooping, key board monitoring or socket snooping. Other techniques may also be employed and although the listed techniques may in and of themselves be considered novel, the present invention is not strictly limited to the disclosed embodiments. Indeed, some EMR systems may include integrated access to such information, either by providing function calls to the system, dumping the data out a port or into files, etc. We define the term scraping to include scraping the display screen, screen buffer snooping, key board monitoring or socket snooping or any other method of getting data in a non-invasive manner.

The ECS Trainer program (ECS-T) is a separate executable program. The ECS-T is used to train the ECS-C as well as the ECS-S. To train the ECS-C, the ECS-T is installed onto the same platform, on which the EMR program is running or has been installed. As one example of an operation, the ECS-T may observe the execution of the EMR program and then operate to capture a session consisting of an end-user navigating (i) to a patient search screen, (ii) providing patient identifier data which provides a list of possible matches, (iii) choosing a specific patient in the list and (iv) receiving the first data screen for the chosen patient. The ECS-C then produces a listing of the data captured. The end-user identifies the specific place in the captured listing where the data for the chosen patient starts and ends. The area between the starting place and the ending place is called the Template. The end-user also marks the zones in the Template that form the patient identifier. The ECS-T then formulates the logic as to how to identify the Template and strip the values in the zones to form the patient identifier information for future operations.

For example, the ECS-T can subsequently follow these operations:

Continue observing the data that is received and displayed on the screen

Determine if the data on the screen includes the title of “Patient Data”

If so titled, strip the values found in the fields called patient name, patient, sex and patient date of birth. These values are collectively referred to as the patient identifier.

Similarly, the Trainer program ECS-T can also be used to train the Server ECS-S.

One embodiment of the present invention includes a method for integrating access to a non-integrated system based on a system state of an active system. Initially, the active system is used to gain access to a data file. The data file includes one or more data values that can be used to look up other information. The data values to be used to look up other information are identified in the data file. When an actuation signal for accessing the non-integrated system is received or detected, the non-integrated system is accessed using the identified data values. The results of the access of the non-integrated system are then provided to the user. In a specific embodiment, the active system may be an EMR system or a physician data system that is used for storing patient records as the data files. In this embodiment, the step of identifying the data values for accessing other information includes obtaining data values that at a minimum uniquely identify the patient. Further, the non-integrated system may be a medical records system that is maintained by an entity other than the entity maintaining the EMR system. In this case, the step of accessing the non-integrated system is performed by using the data values that are associated with the identified patient.

In one embodiment of the invention, the step of providing the results of accessing the non-integrated system includes parsing the data files received from the non-integrated system and displaying the data in accordance with a template.

In various embodiments, the data values from the data file may be obtained in a variety of manners. For instance, the data file may be displayed and data values are identified by scraping the displayed data file. Furthermore, the scraping may also involve searching the displayed data file for key words and then identifying the values associated with the key words. Alternatively, the data values can be obtained by scraping the data that is received on a socket and parsing the data received when gaining access to the data file. Likewise, this may include identifying key words in the data that is received and then identifying values associated with the key words. A socket is analog to a door of a house. A house may have multiple doors. The physical address of the house and the specificity of the door (such as the front door) uniquely identify a door. Analogously, the physical address of a house corresponds to what is called an ip address of a networked computer and the specificity of a door corresponds to a port of a computer. A socket is ip address along with the port number.

In one embodiment of the invention, the step of providing the results of accessing the non-integrated system includes parsing the data files received from the non-integrated system and displaying the data in accordance with a template.

In another embodiment, the invention can be a software program that can be executed on a system hosting a first information system. The present invention can co-exist with the first information system and may operate to monitor an actuator. The software program collects data into and from the first information system as well as the state of the first information system. The term “state” is used to mean the current state plus the data that has been gathered. If the actuator is actuated, the program identifies the current state of the first information system and, based on the current state of the first information system, accesses data on a second information system that is relevant to the state of the first information system. For instance, in one embodiment, the first information system is a physician office system and the software program is operable to identify the current state of the physician office system by scraping a display screen for patient identification information. Furthermore, the software program is operable to access data on the second information system by accessing data records associated with the patient identification information.

These embodiments, as well as the various aspects and features of the present invention will be more fully described in conjunction with the drawings and the detailed description.

### BRIEF DESCRIPTION OF THE SEVERAL VIEWS OF THE DRAWING

FIG. 1 is a block diagram illustrating a communication between an external source and a client.

FIG. 2 is a block diagram that illustrates an EMR setup.

FIG. 3 is a block diagram illustrating multiple physicians accessing the same EMR server.

FIG. 4 is a typical screen lay out illustrating a Patient Data Screen.

FIG. 5 is a block diagram illustrating the embodiment of the present invention within the environment illustrated in FIGS. 1 and 2.

### DESCRIPTION OF THE INVENTION IN TERMS OF A SPECIIFC EMBODIMENT

The present invention is directed towards, among other things, non-invasively capturing data on-line and in real-time as the data is entered or operated on by one system to be used by a second system when the second system is commanded to act.

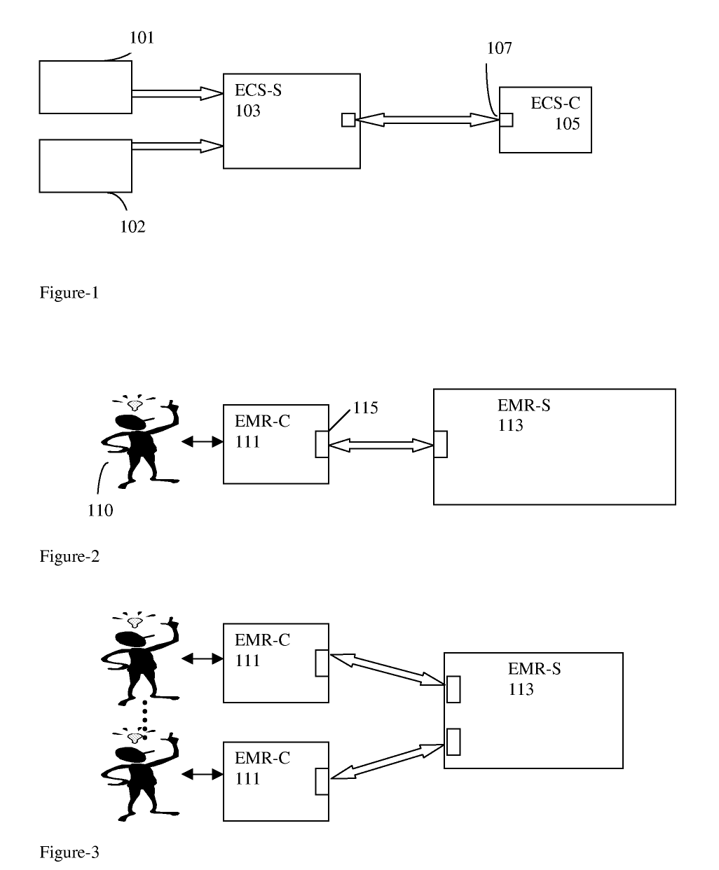

Turning now to the figures in which like elements are represented by like labels in the several views, various aspects, features and functions of embodiments of the present invention are described. FIG. 1 is a block diagram illustrating a communication between an external source and a client. Hospitals 101 and 102 operate to send information to a physician, such as laboratory results or the like. The information transmitted or provided by hospitals or entities 101 and 102 could be for the same patient. Information from both of these hospitals is stored in a repository within the ECS-S 103. The ECS-S 103 can be located in a location that is remote from the physician office. The ECS-S 103 could be shared among several physicians in several physician offices. The Program ECS-C 105 is loaded onto and runs on the physician's PC. Among other things, the ECS-C operates to access and display external data stored in the ECS-S 103. The ECS-C 105 talks to the ECS-S 103 via port 107. The IP address of the PC on which the ECS-C runs along with the port-number of port 107 form the socket address.

FIG. 2 is a block diagram that illustrates an EMR setup. In the EMR setup of FIG. 2, it is assumed that the physician 110 is a part of a group practice and that the practice uses an EMR System that is shared among all of the physicians in the practice. The EMR-C 111 is the client software of the EMR System. The EMR-C 111 interfaces to and communicates with the EMR-S 113, the server that has the database of ambulatory and financial data of all patients in the practice. Data that is exchanged between the EMR-C 111 and the EMR-S 113 is via port 115.

FIG. 3 is a block diagram illustrating multiple physicians accessing the same EMR server. In the embodiment illustrated in FIG. 3, multiple physicians 110 are connected to the same EMR-S 113 with each one having his own EMR-C 111 running on his PC.

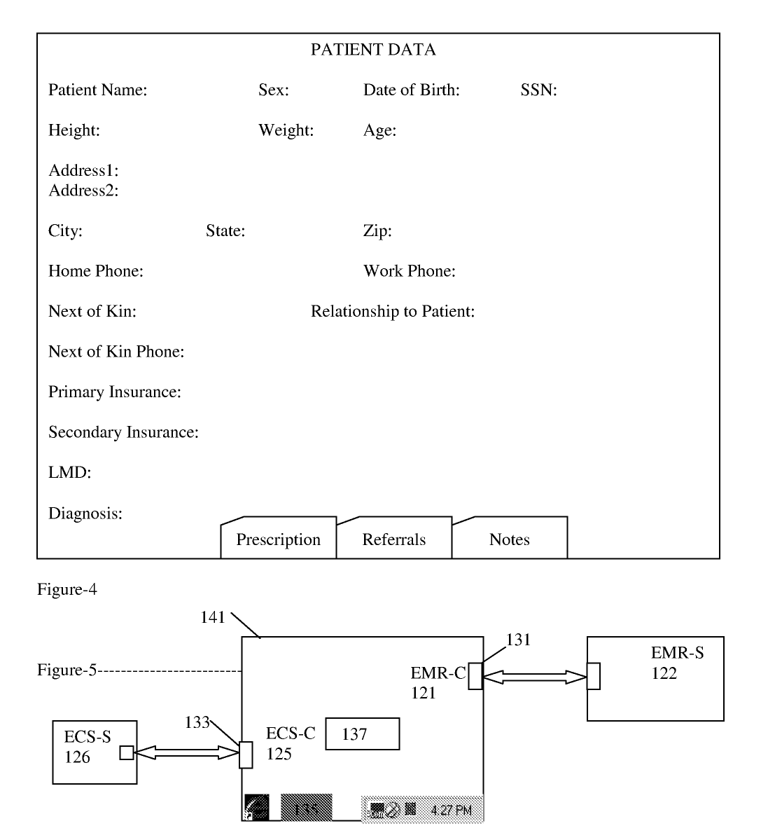

FIG. 4 is a typical screen lay out illustrating a Patient Data Screen. More specifically, FIG. 4 provides an example of the Patient Data Screen Template that can be used to identify the location of data on an EMR screen. A physician searches for a patient by providing partial or complete patient identifier information. Based on the input given by the physician, he may receive one or more matches, all of which will be displayed on the screen of the EMR system with complete identification data. If multiple matches are displayed, the physician will choose a specific one after which he will be shown the Patient Data Screen for the chosen patient. For example, the physician may provide as input Smith. The system will display a list of all of the Smiths in the database showing the complete names, sexes and dates of births. The physician will then select a specific one of the listed elements from the list. The Template Patient Data Screen is the first screen that the physician sees once he has identified a specific patient.

FIG. 5 is a block diagram illustrating the embodiment of the present invention within the environment illustrated in FIGS. 1 and 2. FIG. 5 shows the physician's PC 141 on which both the client for the EMR system (EMR-C) and ECS-C execute. The EMR-C 121 is communicating with the EMR-S via port 131. The ECS-C 125 is communicating with ECS-S 126 via port 133. Ports 131 and 133 are two distinct ports. A special icon 135 is displayed on the taskbar and can be easily selected and evoked to fetch laboratory results. The taskbar shows other icons such as the one to be used to evoke Internet Explorer.

Assume that the IP Address of the PC 141 is 255.191.100.001. As mentioned before, an IP address uniquely identifies a PC.

The ECS-C has two components. One of the components is designed to snoop a specified communication socket. Referring to FIG. 5, the ECS-C 125 is specified to snoop the socket <255.191.100.001;131>. The ECS-C 125 has been trained by the Trainer to watch the traffic on the specified socket through which communication between EMR-C and EMR-S takes place. When the ECS-C 125 observes that the information being sent to EMR-C 121 over the socket 131 corresponds to the Template, it starts capturing information for the entire screen. This identification can be made in a variety of manners including, but not limited to, identifying header information for the transmission, parsing the data looking for particular data patterns, such as labels, observing that the data is received immediately following a request identified as a request for patient information, etc. The ECS-C 125 then parses the patient identifier information that follows to identify constant strings labeled Patient Name:, Sex:, Date of Birth: and then stores the values associated with these constant strings into a file 137. The values may be obtained using standard parsing techniques such as examining white space or tab following the label and looking for white space or other delimiters to identify the end of the data. If the physician decides to review a report from another entity, such as a hospital, the physician simply clicks or selects the icon 135, the ECS-C extracts the patient information values from the file 137 and using them as input, fetches the data from ECS-S 126 and displays the data. Thus, without having to modify or effect the operation of the EMR system, the ECS was able to identify a current patient that is being reviewed by a physician, extract parameters from the physicians typical operations, and then provide easy access to the patient's data from other systems without requiring the physician either to log into another application or provide patient identifier as input.

It should be understood that clicking or activating or selecting an icon in the taskbar is only one example of how the physician can initiate the reception of the data from an external source. Thus, the taskbar icon need not be the only means to fetch the lab data. Fetching the lab data, while the user is in the patient screen could also be triggered by other means such as receiving a voice command, pressing a function key on the key board, entering a key sequence, invoking a short-cut on the desktop, as well as other techniques.

It should also be understood that, even though the above-described embodiments use fetching of lab results as an example of an application of the present invention, one or more icons can be placed in the taskbar or icon tray and utilized to get various types of data or perform other functions. For instance, there could be an icon to fetch patient specific consulting reports that have been sent from consulting physicians. Similarly, an icon or other activator could be used to access other diagnostic information to help assist the physician's analysis. For instance, the information collected by the ECS may include diagnosis information and symptom information. In this case, clicking on the icon may invoke a system that will analyze the diagnosis and symptom information and provide a list of potential problems. In another embodiment, instead of providing multiple icons that can be activated, only a single icon could be presented which when activated can default to a certain set of laboratory results or other default and/or provide options for the physician to further select options for other information. For instance, activating the icon may invoke a menu of possible reports and tools available to the physician. Such menu may be customized and built on the fly based on the currently active patient information record. As previously mentioned, instead of placing icons in the taskbar, the ECS-C can be activated by voice commands. Voice commanded inputs are particularly well suited for this embodiment of the invention because the commands are based on limited vocabulary and further because the number of users that would be using the EMR system in a physician office is limited. A voice-command processor trained and deployed in an environment with a limited number of users and limited vocabulary is more accurate.

A physician usually is interested in having the information of the same type presented to him in an integrated manner. As an example, consider the case when laboratory results come from say two different hospitals. A physician usually likes to see the results presented in a chronological order (from the most recent to least recent) independent of which hospital the result came from. Each result will identify the source, namely the performing hospital name. The information may be presented in a tiled or cascaded fashion, or may be available by navigating through file tabs or other techniques. Regardless, the information can be ordered chronologically, or by any other sorting criteria selected by the physician or designed into the system.

The server application ECS-S and the database may or may not be in the same machine that executes the EMR application. As a matter of fact, ECS-S could reside in a physical location that is different from the physician's office but electronically connected.

Even though the invention has been proposed in the context of healthcare information and EMR, it should be obvious to anyone skilled in the state of the art that the invention also has general applicability. For example, consider an application Al that an individual runs at his home once a week which is used to keeps track of the price quotes for the stocks that the individual follows. Application A1 opens the user's portfolio spreadsheet, where each row of corresponds to one stock. Assume that column1 of the spreadsheet has the name of the stock. The user navigates the cursor on the spreadsheet, places the focus on a row and clicks the icon placed by an another application A2 running on the same PC. Assume that the name of the stock on which the focus is placed is Advanced Micro Systems. The second application A2 running on the same PC first captures the name of the stock which is in column1 of the row on which the user has placed the focus (this could be done by using screen-scraping methodology). The application A2 then translates the name of the stock to a stock symbol (i.e., the stock symbol is a function of the user input, namely column1 of the focused row). The application A2 then sends an URL-parameter-string to a stock lookup site, such as yahoo.com, parses the reply from the Yahoo server and displays the stock price. Note that yahoo.com is assumed to be a web enabled server that stores the database of stock prices supporting browser inputs. The application A2 sends the URL-parameter string behaving as if a browser is sending the string. The string may look something like http://www.yahoo.com/q/cq?s=amd &d=e where amd is the stock symbol corresponding to the stock Advanced Micro Systems. The application A2 sends the string and receives a reply using the same sockets that are used by the browser such as Internet Explorer. In the above example, the application A2 is assumed to have been either trained by a Trainer program or has been specifically custom-developed. The input provided by the application A2 to the yahoo server is a function of the input provided by a user, function in the mathematical sense.

In the above example, it is observed that the invention played no role in how the yahoo application maintained its database or how the yahoo server worked. Applying this observation to the healthcare system example, the invention may or may not have a role in ECS-S. Data repositories such as RHIO (Regional Health Information Organization), EHR (Electronic Health Records) and PHR (Personal Health Records) are examples of ECS-S. Group organizations and communities maintain these repositories for the benefit of physicians, patients and public health officials. These repository servers provide well-defined and detailed interface specifications as to how to access them. These protocols will be embedded in ECS-C. The invention plays no role in these types of repository servers, but plays a role in getting embedded in ECS-C extending the EMR application.

Repositories such as ECS-S are accessed using security protocols and authentication. The access should be compliant with Health Insurance Portability and Accountability Act of 1996 (HIPAA, Title II). ECS-C would be adhering to such security rules.

Although the various aspects of the present invention have been described primarily in the context of fetching or retrieving information and data from a system, it should be understood and appreciated that the various aspects of the present invention are also applicable for pushing or writing data into a system. For example, the physician may push information to a diagnostics center or to a fax machine in an outside pharmacy. In the latter example, when the patient enters the prescription information in the EMR system, ECS-S gets the patient information, the prescription information, insurance information and faxes to a pharmacy a medication order providing all of the information. The pharmacy to which the order is faxed to may be a function of the insurance of the patient and patient's address.

Although it has been described that the program ECS-C runs on the same PC on which the first application, say EMR-C, executes, ECS-C could run on a separate computer and watch the traffic between EMR-C and EMR-S. In such cases, ECS-C can be voice-commanded.

Although various aspects and features of the present invention have been presented, each of which may be separately considered to be novel, the present invention does not require any particular inclusion of such features or aspects and in fact, the present invention may utilize one or more of the presented features and aspects in various embodiments.

What is claimed is:

1. A method for integrating access to a non-integrated system based on a system state of an active system, the method comprising the steps of:
using the active system to gain access to a data file, the data file including one or more pertinent data values;
identifying the one or more pertinent data values;
receiving an actuation signal for accessing the non-integrated system;
accessing the non-integrated system based at least in part on the one or more pertinent data values; and
providing the results of accessing the non-integrated system.

2. The method of claim 1, wherein the active system is an EMR system and the data file is a patient record, and the step of identifying one or more pertinent data values further comprises the step of identifying data values that identify the patient.

3. The method of claim 2, wherein the non-integrated system is a medical records system and the step of accessing the non-integrated system based at least in part on the one or more pertinent data values further comprises accessing data files that are associated with the identified patient.

4. The method of claim 3, wherein the step of receiving an actuation signal comprises the step of receiving the activation of a specialize icon.

5. The method of claim 3, wherein the step of providing the results of accessing the non-integrated system further comprises displaying the data files retrieved from the non-integrated system.

6. The method of claim 1, wherein the active system is an EMR system and the data file is a patient record, and the step of identifying one or more pertinent data values further comprises the step of identifying data values that identify the patient and wherein the non-integrated system is a medical records system and the step of accessing the non-integrated system based at least in part on the one or more pertinent data values further comprises accessing data files that are associated with the identified patient.

7. The method of claim 1, further comprising the step of displaying the data file and wherein the step of identifying the one or more pertinent data values comprises the step of scraping the data file.

8. The method of claim 7, wherein the step of scraping the data file comprises searching the displayed data file for key words and then identifying the values associated with the key words.

9. The method of claim 1, wherein the step of identifying the one or more pertinent data values comprises parsing the data received when gaining access to the data file.

10. The method of claim 9, wherein the step of parsing the data received comprises identifying key words in the data file and then identifying values associated with the key words.

11. A method for providing access to a second source of information based on the data associated with the context of information currently available from a first source of information, the first source of information being a physician office system, the method comprising the steps of:
receiving a patient identifier at the physician office system;
receiving a command to access the second source of information;
capturing patient identifier information from physician office system;
providing the captured patient identifier information as an input to the second system; and
receiving patient identifier pertinent information from the second information.

12. The method of claim 11, wherein the patient identifier information includes a patient name, a patient identifier number, an age, and a gender.

13. The method of claim 11, wherein the step of capturing patient identifier information further comprises the step of capturing the data as entered to the physician office system.

14. The method of claim 11, further comprising after the step of receiving a patient identifier, displaying information pertinent to the patient identifier.

15. The method of claim 14, wherein the step of capturing patient identifier information further comprises the step of scraping the information.

16. The method of claim 15, further comprising the step of displaying an icon that can be activated, and the step of receiving a command to access the second source of information comprises receiving an activation of the icon.

17. A software program that can be executed on a system hosting a first information system and operate in conjunction there with, the software program including instructions which when executed by the system are operable to:
monitor an actuator;
upon detecting the actuation of the actuator, identifying a current state of the first information system; and
based on the current state of the first information system, invoking an action on a second information system, the action being relevant to the state of the first information system.

18. The software program of claim 17, wherein the first information system is a physician office system and the software program is operable to identify the current state of the physician office system by scraping to obtain patient information.

19. The software program of claim 18, wherein the action invoked on the second information system comprises of receiving data from the physician office system.

20. The software program of claim 18, wherein the second information system being a facsimile machine and wherein the action invoked on the facsimile system comprises of receiving a facsimile transmitted from the physician office system.
